(19) United States
(12) Patent Application Publication
(10) Pub. No.: US 2016/0107455 A1
(43) Pub. Date: Apr. 21, 2016

(54) INK JET RECORDING APPARATUS

(71) Applicant: MIYAKOSHI PRINTING MACHINERY CO., LTD., Narashino-shi (JP)

(72) Inventors: Hideo Izawa, Narashino-shi (JP); Takao Namiki, Narashino-shi (JP); Akira Ishikawa, Narashino-shi (JP); Yuuichi Yamazaki, Narashino-shi (JP)

(73) Assignee: MIYAKOSHI PRINTING MACHINERY CO., LTD., Narashino-shi (JP)

(21) Appl. No.: 14/982,900

(22) Filed: Dec. 29, 2015

Related U.S. Application Data
(62) Division of application No. 13/121,864, filed on Mar. 30, 2011.

(30) Foreign Application Priority Data
Oct. 24, 2008 (JP) 2008-274122

(51) Int. Cl. B41J 11/00

(52) U.S. Cl. CPC B41J 11/007

(57) ABSTRACT

Fluttering of paper traveling opposite to and parallel to a nozzle width region of an ink jet head is held down, thereby improving the printing quality.

An ink jet recording apparatus comprises an ink jet printer including printing units whereby a sheet of paper traveling in a paper passage in the form of an arch shaped by a plurality of guide rollers is printed by a plurality of ink jet heads. The ink jet heads of the printing units comprise ink jet heads of on-demand type having a plurality of nozzle rows of a nozzle width region in a direction of travel of paper. The paper passage opposite to nozzle faces of each ink jet head nozzle defined by two guide rollers positioned at an upstream and at a downstream side in the direction of travel of paper, respectively. Respective end portions of the upstream and downstream sides of the nozzle width region of each ink jet head in the direction of travel of paper are positioned at a first and a second area, respectively, which are between the upstream and downstream guide rollers and inside a first and a second point of paper winding contact with the guide rollers but which are approaching to the first and second points of paper winding contact, respectively, as much as possible.

### CROSS-REFERENCE TO RELATED APPLICATIONS

This application is a divisional of U.S. application Ser. No. 13/121,864, filed on Mar. 30, 2011, and wherein U.S. application Ser. No. 13/121,864 is a national stage application filed under 35 U.S.C. §371 of International Application No. PCT/JP2009/065132, filed Aug. 24, 2009, which is based upon and claims the benefit of priority of the prior Japanese Patent Application No. 2008-274122, filed on Oct. 24, 2008, the entire contents of which are incorporated herein by reference.

### TECHNICAL FIELD

The present invention relates to an ink jet recording apparatus with an ink jet head for printing on an continuous sheet of paper by ink jet and, in particular, with on-demand type ink jet head comprising a plurality of nozzle rows which are provided in a direction in which the sheet of paper travels and having a width in the paper traveling direction, the nozzle row having a multitude of ink nozzles which are arranged in a direction of width of the sheet of paper.

### BACKGROUND ART

In a ink jet recording apparatus of this sort, a constant gap which is maintained between the ink jet head and a surface of continuous sheet of paper (printing surface) is recognized as an important requisite to better the printing quality. An ink jet recording apparatus is known as shown in JP 2005-35209 A, which is capable of printing without imparting fluttering to the paper and regardless of the length of the distance between the rollers guiding a sheet of paper traveling opposite to the ink jet head and high-precision printing by an ink jet head having a plurality of nozzle rows in the paper traveling direction.

Also, it has now become essential to arrange an ink mist collector between the ink jet heads as disclosed in JP 2007-136761 A.

These ink jet heads reflect a recent progression in demanded quality of printing products by ink jet recording apparatus. What is broad in width provided with a plurality of nozzle rows in the direction of travel of the paper is being required. As disclosed in JP 2005-35209 A, only the construction as arranging individual ink jet heads opposite to one linearly traveling surface either immediately before or after winding contact onto the paper guide roller causes the problem that it may become difficult to print in a state without imparting fluttering to the paper and regardless of the length of the distance between the rollers.

Also, as regards the arrangement of disposing an ink mist collector between ink jet nozzles as disclosed in JP 2007-136761 A, the problem arises that there may be a deleterious effect such as vibrations of the paper between the ink jet heads due to an air stream for suction recovery of the ink mist by the ink mist collector.

In view of the aforementioned, it is an object of the present invention to provided an ink jet recording apparatus whereby fluttering of a traveling sheet of paper opposite to and parallel to a nozzle width region of an ink jet head is held down to the minimum to better the printing quality and if an ink mist collector is arranged between the ink jet nozzles, vibrations of the sheet of paper by arrangement of the ink mist collector is minimized.

### DISCLOSURE OF THE INVENTION

In order to achieve the object mentioned above, the present invention provides in a first aspect thereof an ink jet recording apparatus which comprises an ink jet printer including printing units whereby a sheet of paper traveling in a paper passage in the form of an arch shaped by a plurality of guide rollers is printed by a plurality of ink jet heads, wherein the ink jet heads of the printing units comprise ink jet heads of on-demand type having a plurality of nozzle rows of a nozzle width region in a direction of travel of paper; the paper passage opposite to nozzle faces of each ink jet head is defined by two guide rollers positioned at an upstream and at a downstream side in the direction of travel of paper, respectively; respective end portions of the upstream and downstream sides of the nozzle width region of each ink jet head in the direction of travel of paper are positioned at a first and a second area, respectively, which are between the upstream and downstream guide rollers and inside a first and a second point of paper winding contact with the guide rollers but which are approaching to the first and second points of paper winding contact, respectively, as much as possible.

The present invention also provides in a second aspect thereof an ink jet recording apparatus as mentioned in the first aspect above wherein the paper passage of a printing unit is in the form of an upwardly bulged arch with respect to a horizontal line and a winding contact angle of the sheet of paper onto each of the two guide rollers for defining the paper passage ranges from 2 degrees to 5 degrees.

The present invention also provides in a third aspect thereof an ink jet recording apparatus as mentioned in the first or second aspect wherein each ink jet head of the printing unit is fixed via a head substrate to a fixing substrate which is parallel to the paper passage opposite to each ink jet head, wherein the head substrate has one end in the paper width direction as a fulcrum so that the head substrate can be rocked around the fulcrum on the fixing substrate.

The present invention also provides in a fourth aspect thereof an ink jet recording apparatus as set forth in the first or the second or the third aspect above wherein ink mist collectors are disposed between a plurality of ink jet heads of the printing unit, a suction port of the ink mist collectors is opposite to a portion adjacent to the point of paper winding contact with the downstream side guide roller of the two guide rollers to which the upstream side ink jet head is opposite, and an air outlet or a suction port of the ink mist collectors is opposite to a portion adjacent to the point of paper winding contact with the upstream side guide roller of the two guide rollers to which the downstream side ink jet head is opposite.

The present invention also provides in a fifth aspect thereof an ink jet recording apparatus as set forth in the first or the second or the third or fourth aspect above wherein the two printing units of the ink jet printer are spaced and arranged one above the other to allow a sheet of paper to travel sequentially in paper passages in both the printing units for printing on both sides of the paper.

The present invention also provides in a sixth aspect thereof an ink jet recording apparatus as set forth in the first or the second or the third or the fourth or the fifth aspect wherein at a downstream side of the paper passage of each printing unit a drying unit is disposed.

The present invention also provides in a seventh aspect thereof an ink jet recording apparatus as set forth in the first or the second or the third or the fourth or the fifth or the sixth aspect above wherein a fixing substrate for securing each ink jet head of the printing unit and each ink mist collector is securely supported by a head box, and the head box is made movable laterally of the paper passage.

According to the first aspect of the present invention, the traveling length of a path of the paper parallel to and opposite to the nozzle width region of the ink jet head is allowed to approach to the length proximate to that of nozzle width region as much as possible. This holds down fluttering of the paper, thereby improving the printing quality.

Also, according to the second aspect of the present invention, the fact that the paper passage of a printing unit is in the form of an upwardly bulged arch with respect to a horizontal line and a winding contact angle of the sheet of paper onto each of the two guide rollers for defining the paper passage ranges from 2 degrees to 5 degrees allows each ink jet head provided at a paper side of the paper passage to be mounted substantially beneath and thus mounted under preferred conditions.

Also, according to the third aspect of the present invention, allowing the head substrate to be rocked with respect to the fixing substrate, the ink jet head secured to the head substrate can be adjusted in paper traveling direction,

Also, according to the fourth aspect of the present invention, the ink mist in the printing part by each ink jet head can be collected efficiently and the influence of the air flow of the ink mist collector on the paper part is prevented and thus high precision printing is achieved.

Also, according to the fifth aspect of the present invention, two printing units in which both front and rear surfaces of a sheet of paper can be printed are mounted one above the other. Space saving is achieved compared with the two printing units arranged in paper traveling direction.

Also, according to the sixth aspect of the invention, the printing area printed by each printing unit can be immediately dried. It prevents from becoming dirty by rubbing with a guide roller.

Further, according to the seventh aspect of the invention, by moving each ink jet head of a printing unit and an ink mist collector laterally of the paper passage, the maintenance can be easily achieved.

### BRIEF DESCRIPTION OF THE DRAWINGS

In the Drawings:

FIG. 1 is an explanatory view diagrammatically illustrating a first form of implementation according to the present invention;

FIG. 2 is an explanatory view diagrammatically illustrating a second form of implementation according to the present invention;

FIG. 3 is a cross sectional view illustrating one aspect of the present invention;

FIG. 4 is a perspective view illustrating the above illustrated aspect of the FIG. 5A is a perspective view illustrating a head substrate, and FIG. 5B is a perspective view illustrating a fixing substrate.

FIG. 6 is a fragmentary view illustrating an oscillating unit for the head substrate;

FIG. 7 is a plan view diagrammatically illustrating a printing unit; and

FIG. 8 is a plan view illustrating an alternative form of implementation of the ink jet head.

### BEST MODES FOR CARRYING OUT THE INVENTION

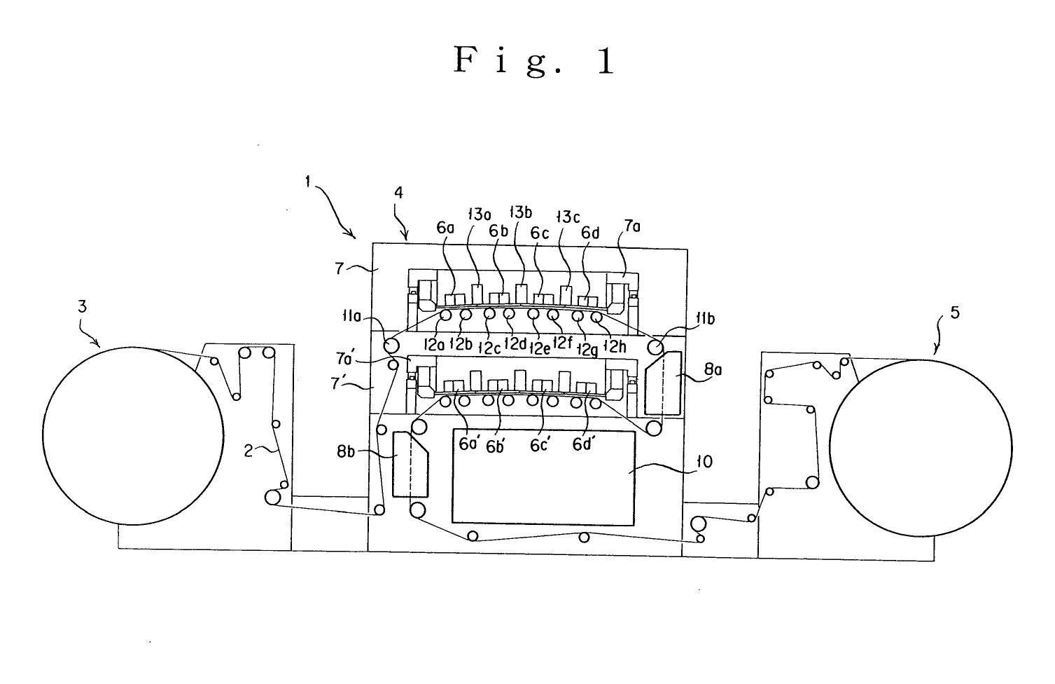

FIG. 1 diagrammatically shows an ink jet recording apparatus 1 according to a first form of implementation of the present invention. The ink jet recording apparatus 1 comprises a paper feeder 3 for feeding a sheet of paper 2, an ink jet printer 4 for printing on a sheet of paper 2 fed from the paper feeder 3 with an ink jet head and a takeup unit 5 for taking up a sheet of paper 2 printed at the ink jet printer 4.

The ink jet printer 4 comprises a first and a second printing unit 7 and 7′ arranged one above the other and having a plurality of, e.g., four (Y, M, C, K) ink jet heads 6a, 6b, 6c and four ink jet heads 6d and 6a′, 6b′, 6c′ and 6d′ disposed in a direction of travel of a sheet of paper 2, respectively.

And, in the first form of implementation of the preset invention, when a feeding direction of the sheet of paper 2 fed from the paper feeder 3 is assumed as a forward direction of travel and the reverse is assumed as a reverse direction of travel, the sheet of paper 2 fed from the paper feeder 3 travels forwardly in the first printing unit 7 and then is printed through the ink jet heads 6a-6d on its obverse (upper) side surface in a preselected pattern, and thereafter is turned 180 degrees, i.e., its reverse side is turned upwards and travels reversely in the second printing unit 7′ and then is printed through the ink jet heads 6d′-6a′ on its reverse side surface in a preselected pattern.

Note, here, that at the outsides of exits of the printing units 7 and 7′ there are provided a first and a second drying unit 8a and 8b, respectively, to dry the sheets of paper 2 leaving the printing units 7 and 7′ while they are traveling through these drying units 8a and 8b.

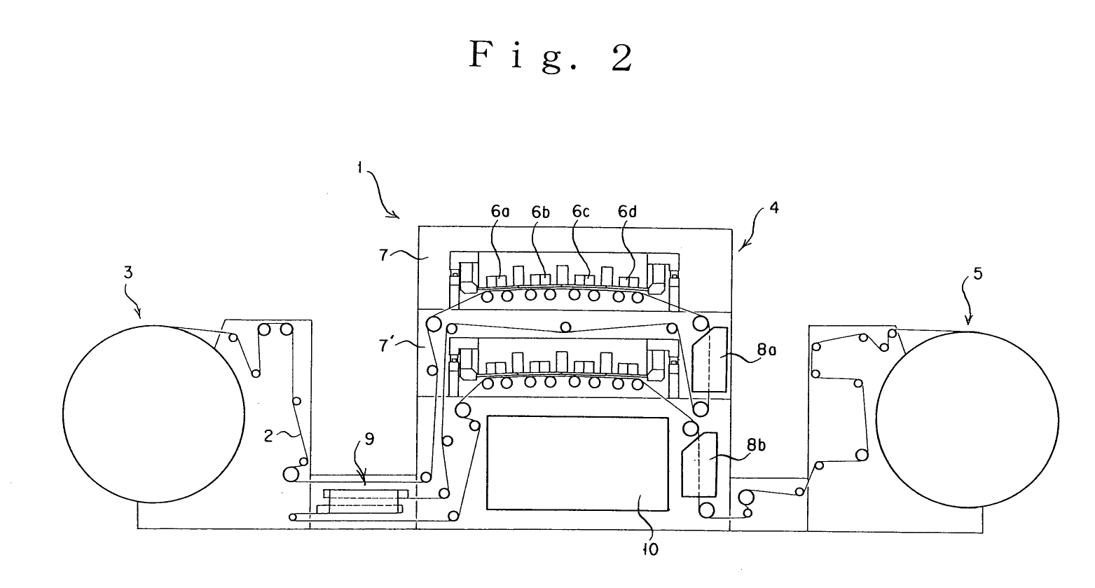

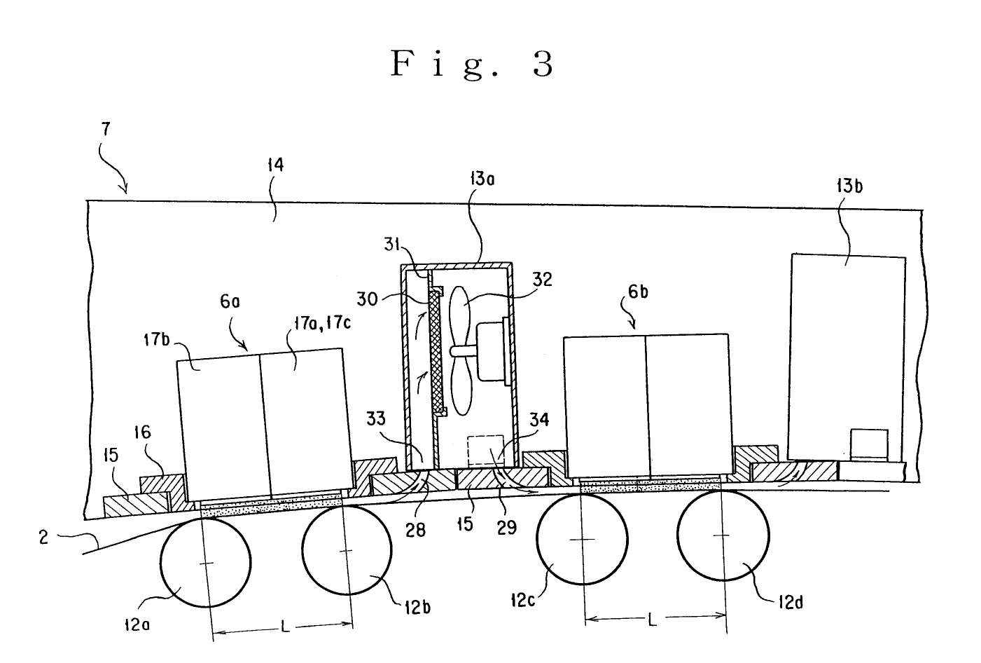

FIG. 2 shows a second form of implementation of the present invention in which the same reference characters used in the first form of implementation identify the same members. The sheet of paper 2 fed from the paper feeder 3 travels forwardly in the first printing unit 7 and then is printed through the ink jet heads 6a-6d on its obverse (upper) side surface in a preselected pattern, and thereafter is turned 180 degrees to be guided upstream of the second printing unit 7′ in the forward direction of travel. A turn bar 9 is provided in the forward direction of travel to turn the reverse side of the sheet of paper 2 upward. Now traveling forwardly in the printing unit 7′, the sheet of paper 2 is printed through the ink jet heads 6d′-6a′ on its reverse side surface in a preselected pattern. Then, the sheet of paper 2 is dried after printing by a drying unit 8b provided downstream of the second printing unit 7′.

To wit, in the first and second forms of implementation, the obverse side surface of the sheet of paper 2 is printed while the sheet of paper is traveling forwardly in the first printing unit 7. In the first form of implementation, the reverse side surface of the sheet of paper 2 is printed while the sheet of paper is traveling reversely in the second printing unit 7′. In the second form of implementation, the sheet of paper 2 is reversed and travels forwardly in the second printing unit 7′ to be printed on its reverse side surface.

In both forms of implementation, in each of the printing units 7 and 7′ each of the ink jet heads 6a-6d, 6a′-6d′ is controlled by a control unit 10. The control unit 10 is placed at a position which is difference from the ink jet head positions, e.g., a lower portion of the ink jet recording apparatus.

Each of the ink jet heads 6a-6d, 6a′-6d′ is operated in a printing mode by the control unit 10 in timing with detection signals from a mark sensor (not shown) which senses marks preprinted on the sheet of paper 2. Each of the ink jet heads may be normally controlled by the control unit 10 and operated in a printing mode.

In each of the forms of implementation mentioned above, the first and second printing units 7 and 7′ are basically the same in configuration. The second printing unit 7′ is designed so that the sequence of operation of the ink jet heads 6a′-6d′ is controlled by the control unit 10 according to the direction of travel of the sheet of paper 2.

Mention is next made of the first and second printing units 7, 7′ which are made of an identical configuration. Mention may be made of the first printing unit 7 alone.

At both sides of the printing unit 7 in the direction of travel of the paper are provided feed rollers 11a and 11b making the sheet of paper 2 travel, imparting a selected tension to the paper 2. The paper passage between the rollers 11a and 11b comprises guide rollers 12a, 12b, 12c, 12d, 12e, 12f, 12g and 12h for guiding the sheet of paper 2 and is in the form of an upwardly bulged arch with respect to a horizontal line. And, at the upper side of and along the paper passage, there are disposed ink jet heads 6a-6d. And, between the ink jet heads 6a-6d, there are arranged ink mist collectors 13a, 13b and 13c.

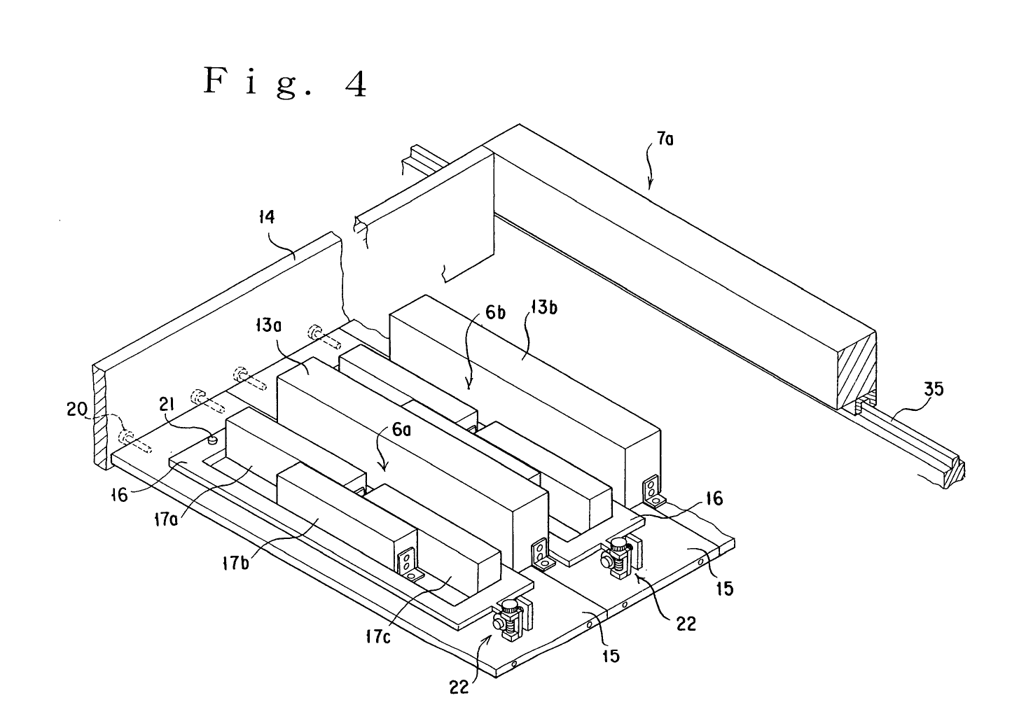

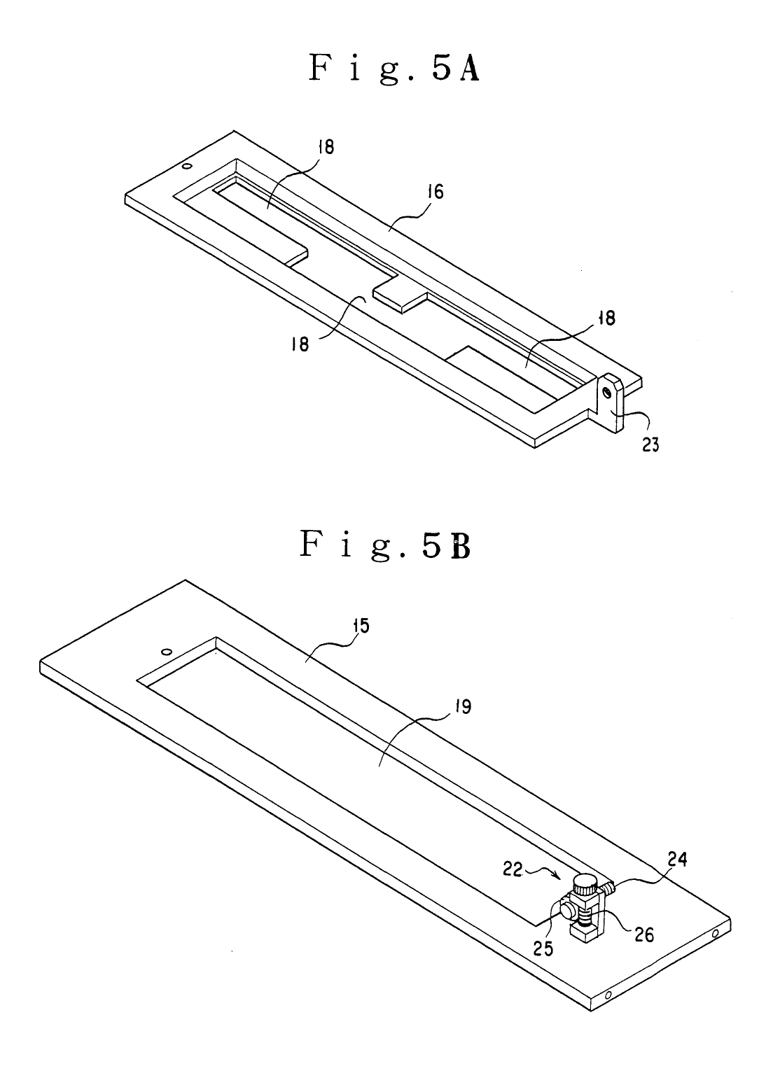

The ink jet heads 6a-6b and the ink mist collectors 13a-13b are identical in design and configuration, respectively. A set of an ink jet head and an ink mist connector is mentioned referring to FIGS. 3 and 4.

The ink jet head 6a is fixed via a head substrate 16 to a fixing substrate 15 fastened to a side frame 14 mounted on a head box 7a within the printing unit 7. The fixing substrate 15 is provided for each ink jet head. The ink jet head 6a used is an on-demand type ink jet head comprising a plurality of nozzle rows arranged within a selected width in the direction of travel of the paper 2. And, the width of the nozzle rows constitutes a nozzle width region L for printing.

The ink jet head 6a is hard to obtain the selected nozzle width region L and the length in the width direction of the paper 2. As shown in FIG. 4, a plurality of, e.g., three print head 17a, 17b and 17c may be arranged in a staggered form to obtain a selected nozzle width region L in the direction of travel of the paper and a nozzle length region in the width direction of the paper.

The head substrate 16 to which each print head 17a, 17b, 17c is fixed and the fixing substrate 15 to which the head substrate 16 is fixed are as shown in FIGS. 5A and 5B. As shown, the head substrate 16 is formed with a head window 18 orienting downward a nozzle portion of each print head 17a, 17b, 17c and the fixing substrate 15 is formed with an entire nozzle range window 19 including a nozzle width region L in the width direction of the ink jet head 6a (paper travel direction) and including a nozzle length region in the longitudinal direction of the ink jet head 6a (paper width direction).

And, the fixing substrate 15 as mentioned above is secured to the side frame 14 via a fixing bolt 20 (refer to FIG. 4). Also, the head substrate 16 has one end in longitudinal direction pivotably supported by a fulcrum pin 21 so that the other end in the longitudinal direction may be rocked around the fulcrum pin 21 on the upper surface of the fixing substrate 15 through a rocking unit 22.

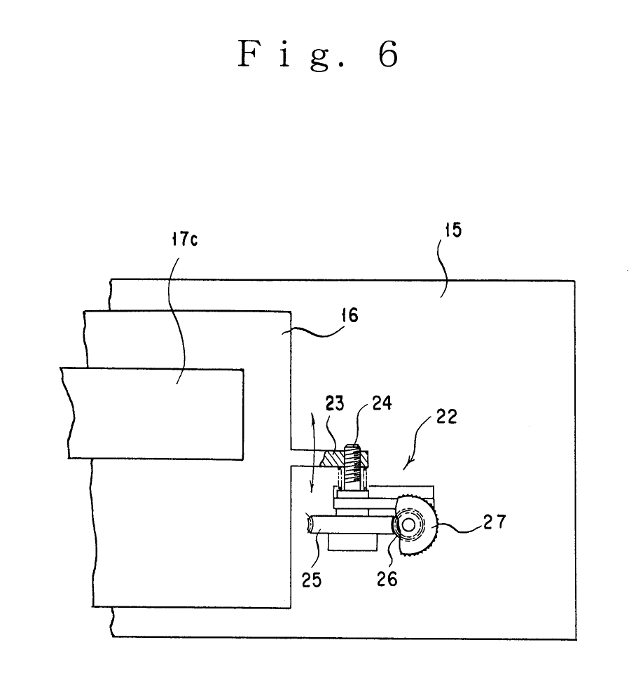

The rocking unit 22 as shown, e.g., FIG. 6, comprises a screwed rod 24 screwed to the lever member 23 projecting from the end of the head substrate 16 and parallel to the upper face of the head substrate 16, and a worm wheel mechanism including a worm wheel 25 fastened to the screwed rod 24, a worm 26 in mesh with the worm wheel 25 and a handle 27 for rotating the worm 26. And, rotating the handle 27 to rotate the screwed rod 24 via the worm wheel mechanism allows the head substrate 16 to be rocked around the fulcrum pin 21 on the fixing substrate 15.

As shown in FIG. 4, an ink mist collector 13a between the ink jet heads is secured to one of the fixing substrates 15 provided for ink jet heads 6a and 6b. And, as to both the fixing substrates 15, 15 which adjoin each other in the traveling direction of the sheet of paper 2, the upstream side fixing substrate 15 has a suction port 28 opening towards the downstream side end of the nozzle width region of the upstream side ink jet head 6a. Also, the downstream side fixing substrate 15 has an air outlet port 29 opening towards the upstream side end of the nozzle width region of the downstream side ink jet head 6b.

The ink mist collector 13a comprises a partition plate 31 having a filter 30 and a rotary fan 32 opposing to the filter 30 and rotating in a direction in which to draw a wind from the filter 30. There is provided a suction port 33 communicating with the suction port 28 upstream of the partition plate 31 and also an air outlet 34 communicating with the air outlet 29.

Tow of the guide rollers 12a-12h constituting the paper passage in the printing unit 7 are provided for each of the ink jet heads 6a-6d, And, the positional relationship of each ink jet head and the two guide rollers is mentioned with reference to the upstream-most ink jet head 6a in the direction of travel of the paper 2 and the guide rollers 12a and 12b as shown in FIG. 3.

First, the fixing substrate 15 for securing and supporting the ink jet head 6 via the head plate 16 is parallel to the paper passage comprising the two guide rollers 12a and 12b and secured to the side frame 14 so that the nozzle surface of the ink jet head 6a is parallel to the paper passage comprising the two guide rollers 12a and 12b. And, the respective terminal end portions of the upstream and the downstream sides of the nozzle width region L of the ink jet head 6a in the direction of travel of the paper 2 are positioned at a first and a second area, respectively, which are between the upstream and downstream guide rollers 12a and 12b and inside a first and a second point of paper winding contact but which are approaching to these points of paper winding contact with the guide rollers, respectively, as much as possible.

This allows the length of a traveling path of the paper linearly traveling parallel to and opposite to the nozzle width region L of the ink jet head to approach to the length proximate to that of the nozzle width region L, as much as possible. The result is that fluttering of the paper 2 within the nozzle width region L is held down to the minimum.

The positional relationship between the other ink jet head and the two guide rollers are identical to the positional relationship between the ink jet head 6a and the two guide rollers 12a and 12b. Note in this connection that for forming an arched paper passage, the winding contact angle of the sheet of paper 2 onto the guide roller 12a-12h ranges between 2 and 5 degrees.

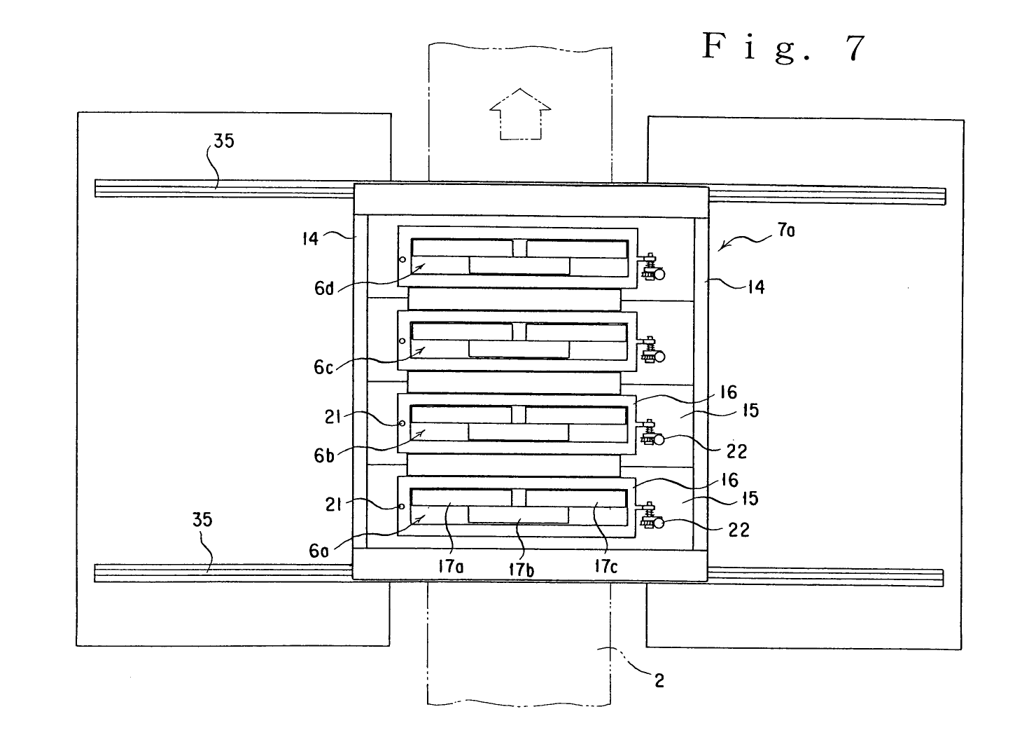

As regards the printing units 7 and 7′ in the forms of implementation described above, the side frames 14 for securely supporting the fixing plate opposite to the paper passage comprising the guide rollers 12a-12h is secured to the head box 7a. This head box 7a as shown in FIG. 7 is movable along a slide rail 35 in a direction orthogonal to the traveling direction of the sheet of paper 2. From a printing position at which the ink jet head is opposite to the sheet of paper 2, moving of the head box 7a in one direction allows maintenance and moving of the head box 7a in the other direction allows purging.

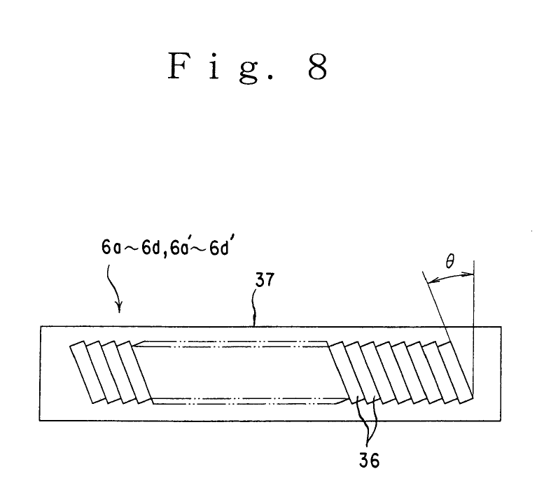

In the ink jet head 6a-6b and 6a′-6d′ in the forms of implementation described above, in order to widen the nozzle width region L, an example is shown in which a plurality of print head 17a-17c are arranged in the staggered form. This ink jet head configuration is not a limitation. For example, as shown in FIG. 8, a multiplicity of nozzle heads 36 is arranged by inclining them at a selected angle of inclination 6. Thus formed line head 37 can be secured to a fixing substrate via a head substrate.

While in the forms of implementation illustrated, ink jet heads 6a-6b and 6a′-6d′ are secured via the head substrate 16 to a fixing substrate 15 which is separately formed for each ink jet head, it will be appreciated that a mounting member for each ink jet head may be adjustable to be parallel to the paper passage opposite thereto and thereby all ink jet heads can be mounted on a single fixing plate 15.

In the ink mist collector 13a-13c, the fan 32 may be modified to orient an effusion upward to provide an air outlet through an upper wall and the fixing substrate 15 may also be modified to draw air through an air outlet 29.

What is claimed is:

1. An ink jet recording apparatus, comprising:
an ink jet printer including printing units whereby a sheet of paper traveling in a paper passage in the form of an arch shaped by a plurality of guide rollers is printed by a plurality of ink jet heads, wherein,
the ink jet heads of the printing units comprise ink jet heads of on-demand type having a plurality of nozzle rows of a nozzle width region in a direction of travel of paper,
the paper passage opposite to nozzle faces of each ink jet head is defined by two guide rollers positioned at an upstream and at a downstream side in the direction of travel of paper, respectively, and
respective end portions of the upstream and downstream sides of the nozzle width region of each ink jet head in the direction of travel of paper are positioned at a first and a second area, respectively, which are between the upstream and downstream guide rollers and inside a first and a second point of paper winding contact with the guide rollers but which are approaching closely to the first and second points of paper winding contact,
wherein the paper passage of a printing unit is in the form of an upwardly bulged arch with respect to a horizontal line and a winding angle of the sheet of paper onto each of the two guide rollers for defining the paper passage ranges from 2 degrees to 5 degrees, and
wherein ink mist collectors are disposed between a plurality of ink jet heads of the printing unit, a suction port of the ink mist collectors is opposite to a portion adjacent to the point of paper winding contact with the downstream side guide roller of the two guide rollers to which the upstream side ink jet head is opposite, and an air outlet or a suction port of the ink mist collectors is opposite to a portion adjacent to the point of paper winding contact of the upstream side guide roller of the two guide rollers to which the downstream side ink jet head is opposite.
